(19) United States
(12) Patent Application Publication
(10) Pub. No.: US 2009/0093785 A1
(43) Pub. Date: Apr. 9, 2009

(54) Environmental Detector

(75) Inventors: Helen Brown, Leicestershire (GB); Darren Hodson, Leicestershire (GB); Rachel Jury, Chesterfield (GB); Simon Newey, West Midlands (GB); Aziz-ur Rehman, West Midlands (GB)

Correspondence Address: FISH & RICHARDSON P.C., P.O BOX 1022, MINNEAPOLIS, MN, 55440-1022, US

(73) Assignee: ASTRAZENECA AB, SE-151 85 Södertälje (SE)

(21) Appl. No.: 11/994,057

(22) PCT Filed: Jun. 28, 2006
(86) PCT No.: PCT/SE06/00792

§ 371 Date: Jun. 24, 2008

(30) Foreign Application Priority Data
Jun. 30, 2005 (SE) 0501541-7

(51) Int. Cl. A61J 1/18; G01D 9/28; G01K 3/00; G08B 21/18

(52) U.S. Cl. 604/404; 206/528; 374/141; 340/584

(57) ABSTRACT

An environmental sensor device for detecting environmental conditions within a pharmaceutical product package is described. The sensor device is a stand alone device that includes: a housing defining the outer dimensions of the sensor device, a humidity sensor, a temperature sensor, a control circuit, a memory circuit, a power source and a communications interface. The housing has outer dimensions that allow it to fit inside a pharmaceutical product package. A system and method for evaluating best before date for pharmaceutical products are also described.

### CROSS-REFERENCE TO RELATED APPLICATIONS

This application is a national phase application under 35 U.S.C. §371 of PCT International Application No. PCT/SE2006/000792, filed Jun. 28, 2006, which claims priority to Swedish Application Serial No. 0501541-7, filed Jun. 30, 2005. The contents of each of these applications are incorporated herein by reference in their entirety.

### TECHNICAL FIELD

The present invention relates to the art of environmental detectors, and in particular to a detector, a system and a method for detecting environmental conditions inside pharmaceutical product packets.

### BACKGROUND OF THE INVENTION

Many pharmaceutical products are sensitive to environmental influence such as temperature and/or humidity, and are therefore provided in sealable containers or product packages that shields the products from the ambient environment. Such product packages for pharmaceutical products can be of many different types, such as tablet pots of various forms with re-sealable lids of screw on type or snap-on type, small or large blister packs that cannot be re-sealed, etc. One common feature for all types of product packages is that they provide an essentially sealed environment for the pharmaceutical product placed inside. Even though the basic designs of available product packages are relatively similar, the performance and robustness due to external environmental influence varies.

When determining best before date for pharmaceutical products in a specific product package, one main parameter to be investigated is therefore the shielding capacity of the product package. In the prior art this has been performed by placing one or more environmental sensors inside the product package, the sensors being connected to a control unit by wire or wireless connection for real time registration of the environmental parameters inside the package, and by placing the packet in an environmental chamber. When the sensors are connected to the control unit by wires, there must be provided a through-connection through the wall of the package, which therefore must be adequately sealed in order to not influence the shielding performance. WO 0391679A1 discloses a wireless sensor for registering temperature within a pharmaceutical package in the form of a blister pack. This sensor requires wireless connection to a control unit to function, but it provides detection of temperature within a sealed package without the need for any through-connections. Thereafter, the registered data is evaluated, and the shelf life for a specific product and product package combination is estimated. Such estimation is limited to an estimation of the external environmental conditions that the product package is subjected to during e.g. shipping and/or storage.

As an alternative to the estimation of shelf life in accordance with above, there are also devices for registering the actual external conditions that the product packages are subjected to. U.S. Pat. No. 6,810,350 and EP 1262161 disclose pharmaceutical product packages with integrated sensor units for registration of environmental parameters within the package. More in detail, U.S. Pat. No. 6,810,350 discloses a system for active determination of pharmaceutical expiration date, which registers temperature and bases a calculation of expiration date upon registered temperature history. U.S. Pat. No. 4,972,099, EP 0511807 A1, EP1319928 A1 and WO8903020 all disclose examples of stand alone environmental sensor units with data logging capability. The sensor units are intended to be used for automated supervision of environmental conditions, e.g., during shipping of temperature-sensitive goods such as food or pharmaceutical products. The stored environmental data is thereafter transferred to a computer for analysis.

However, the estimations of external environmental influence using the above sensor units and systems have limitations in accuracy and do not provide fully reliable internal environmental data corresponding to real conditions.

### SUMMARY OF THE INVENTION

A new environmental sensor device, a system for determining best before date and a method of evaluating the environmental protection provided by a pharmaceutical product package are described.

One advantage of the stand alone sensor device is that it is small enough to be placed fully inside a pharmaceutical product package, and can be used to record real environmental conditions inside the package.

Another advantage is that it is small enough to be placed inside the product package together with a quantity of a medical product, whereby the recorded environmental data will be even more realistic. Still another advantage is that no through-connection for connection wires has to be furnished in the package, nor is any direct wireless connection needed during the evaluation period, as the sensor device is provided with a memory circuit for storing data.

Still another advantage is that the method according to one embodiment provides more accurate determination of best before date for pharmaceutical products that are sensitive to environmental influence.

### BRIEF DESCRIPTION OF THE DRAWINGS

FIG. 1 is a block diagram of an environmental sensor device and system.

FIG. 2 shows a cross sectional view of a pharmaceutical product package with an environmental sensor device placed inside.

### DETAILED DESCRIPTION

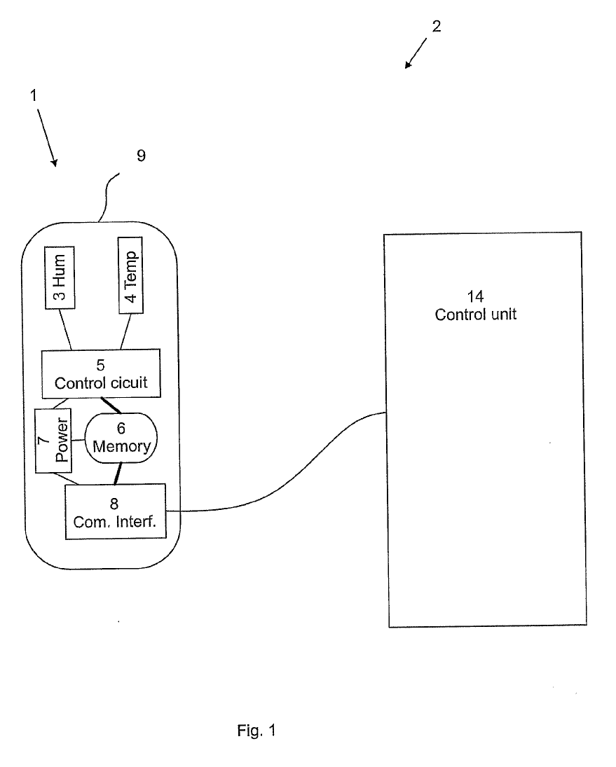

FIG. 1 shows a block diagram of an environmental sensor device 1 and system 2 for detecting environmental conditions within a pharmaceutical product package. The sensor device 1 is a stand alone device with a humidity sensor 3, a temperature sensor 4, a control circuit 5, a memory circuit 6, a power source 7 and a communications interface 8. Further, the sensor device 1 has a housing 9 defining its outer dimensions that allows the sensor device 1 to fit inside a pharmaceutical product package. Pharmaceutical product packages are available in a large variation of sizes and shapes, therefore the dimensions of the sensor device are as small as possible, while still preserving the specified functionality. According to one embodiment, the sensor device is formed as a cylinder with a diameter of 25 mm or less and a length of 50 mm or less. According to one embodiment, one or more of the sensors and circuits are provided in an integrated circuit performing several functions. In fact, all components of the sensor apart from the power source could be provided in one integrated circuit, whereby the sensor device will be extremely small sized.

The sensor system 2 further comprises a control unit 14 being arranged to communicate with the sensor device 1 via the communication interface to receive environmental parameter data for evaluation.

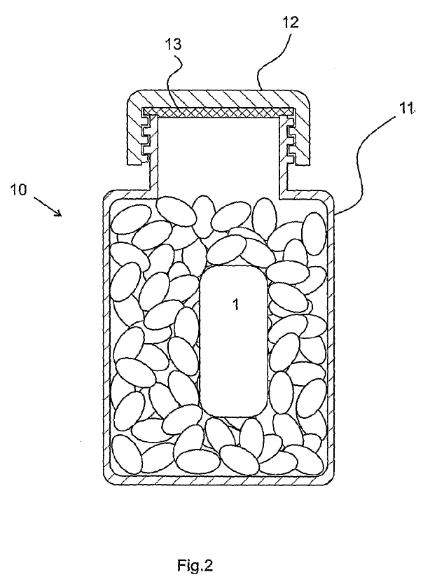

Preferably, as is shown in FIG. 2, the outer dimensions of the sensor device are small enough to permit a quantity of a pharmaceutical product 10 to be placed in a pharmaceutical product package 11 in addition to the sensor device 1. The product package 11 shown in FIG. 2 is a tablet bottle with a screw on lid 12 with a sealing gasket 13. By placing the sensor device 1 together with a quantity of the pharmaceutical product 10 in the package 11, the registered environmental parameters will be even more representative for the product and package combination 10, 11, as the influence of the product, such as insulation, water absorption, etc. is registered.

In order to save power and to avoid excessive data registration, the device 1 is arranged to log temperature and humidity at predetermined intervals. According to one embodiment, the duration of the intervals is random. According to another embodiment, the logging of environmental parameters is initiated by one or more readings of temperature and/or humidity that meets a predetermined criteria. The criteria for initialization of the logging may, e.g., be a slope of temperature and/or humidity increase.

The environmental sensor device 1 is preferably used for evaluating the environmental protection provided by a pharmaceutical package 11. It may also be used for evaluating the function of drying agent in a pharmaceutical package 11, or for evaluating environmental influence on pharmaceutical products 10 during transport, or for determining best before date of products 10 in a pharmaceutical product package 11.

According to another embodiment, there is provided a system 2 for determining best before date for pharmaceutical products 10 contained in a pharmaceutical package 11. The system 2 includes a stand alone environmental sensor device 1 for detecting environmental parameters inside the pharmaceutical product package 11 during a predefined external environmental evaluation cycle. The sensor device 1 is sized to fully fit inside the pharmaceutical product package 11, and a control unit 14 is arranged to communicate with the sensor device 1 via the communication interface 8 to receive environmental parameter data for evaluation.

According to one embodiment of the system 2, the sensor device includes a memory 6 for storing environmental parameter data, and the control unit 14 is arranged to read the stored environmental data from the sensor device 1 after the evaluation cycle. Alternatively, the communication interface 8 is wireless, and the control unit 14 is arranged to read environmental data from the sensor device 1 in real-time during the evaluation cycle.

A method of evaluating the environmental protection provided by a pharmaceutical product package 11 includes:

placing an environmental parameter sensor device 1 capable of storing registered environmental data in the product package 11,
exposing the product package 11 containing the sensor device 1 to environmental changes,
retrieving the registered environmental data to a control unit 14, and evaluating the protection.

In order to register as realistic environmental data as possible, the above method can also include one or more of the steps:—placing a quantity of a pharmaceutical product 10 in the product package 11,
arranging a drying agent in the product package 11, and
closing the product package 11, in the same manner as it would be closed in a real filling situation.

By these measures any influences from the product itself, a drying agent or the filling process are recorded and can therefore be evaluated. Such measures are especially useful to detect potential residual water content in the pharmaceutical product, and to optimize the amount of drying agent that is needed to keep the humidity at a predefined level. Moreover, the method effectively identifies any problems in the filling process, when the environmental data for packages closed in real filling situations are compared with data from packages closed under optimum conditions.

As is mentioned above, it is a complex task to set the best before date for pharmaceutical products, depending on the environmental parameters that the products often are exposed to during transport, storing etc. Due to such uncertainties, the best before date is most often based on worst case scenarios that are not likely to occur. However, a method that can be used for evaluation of best before date after transport and/or storing etc., includes:
placing a product package containing a sensor device 1 in a transport batch, and
registering, using a control unit 14, the environmental history at arrival to destination or after storage.

By such a method, the best before date can be remarkably postponed as the estimation errors are much smaller when the environmental history is complete.

As discussed above, there are product packages/dispensers for pharmaceutical products with integrated sensor units for registration of environmental parameters within the package and even systems for active determination of pharmaceutical expiration date. However, many pharmaceutical products are intended for use under a very limited period of time, such as antibiotics prescribed due to a bacterial infection at a dose of two pills per day during one week or 10 days. In order to achieve a more efficient determination of the best before date for such products (especially for sensitive products), the above method can be used.

1-18. (canceled)

19. A pharmaceutical package comprising:
packaging defining an interior volume;
a pharmaceutical product contained within the interior volume; and
an environmental sensor device contained within the interior volume and configured to detect environmental parameters inside the pharmaceutical package during a predefined environmental evaluation cycle, and to communicate environmental data to an external control unit outside of the package.

20. The package of claim 19, wherein the sensor device comprises a memory device that stores environmental data detected during the evaluation cycle.

21. The package of claim 19, wherein the sensor device is configured to communicate environmental data during the evaluation cycle.

22. The package of claim 19, wherein sensor device comprises a communication interface, and wherein the control unit is configured to communicate with the sensor device via the communication interface.

23. The package of claim 22, wherein the communication interface is a wireless communication interface.

24. The package of claim 19, wherein the sensor device is formed as a cylinder with a diameter of less than about 25 mm and a length of less than about 50 mm.

25. The package of claim 19, wherein the environmental parameters comprise temperature and humidity.

26. The package of claim 19, wherein the packaging is sealed to prevent air ingress into the interior volume.

27. A method of evaluating an environment inside a pharmaceutical package, the method comprising:
(a) placing an environmental sensor device in the package;
(b) placing a pharmaceutical product in the package;
(c) sealing the package with the sensor device and pharmaceutical product contained therein;
(d) exposing the sealed package containing the sensor device to environmental changes; and
(e) while the package remains sealed with the pharmaceutical product therein, retrieving environmental data from the sensor device indicative of the environmental changes.

28. The method according to claim 27, wherein retrieving environmental data comprises retrieving temperature and humidity data.

29. The method according to claim 28, further comprising assessing the retrieved environmental data to determine a best before date of the pharmaceutical product.

30. The method according to claim 27, further comprising assessing the retrieved environmental data to determine a residual moisture content of the pharmaceutical product.

31. The method according to claim 27, further comprising placing a drying agent in the package.

32. The method according to claim 31, further comprising assessing the retrieved environmental data to determine an amount of the drying agent needed to keep the humidity in the package at a predefined level.

33. The method according to claim 27, further comprising:
(a) placing the product package containing the sensor device in a transport batch; and
(b) assessing the environmental data after a length of time to determine a best before date for the pharmaceutical product.

34. A sensor device comprising:
a housing defining the outer dimensions of the sensor device, wherein the outer dimensions of the sensor device allow placement of the sensor device inside the pharmaceutical package, and wherein the housing carries:
(a) a sensor for sensing environmental conditions in the package;
(b) a memory circuit for storing data from the sensor; and
(c) a communication interface arranged to facilitate transfer of the data to an external control unit.

35. The sensor device of claim 34, wherein the sensor comprises a humidity sensor.

36. The sensor device of claim 34, wherein the sensor comprises a temperature sensor.

37. The sensor device of claim 34, further comprising one or more additional sensors, and wherein the sensors are provided in one integrated circuit.

38. The sensor device of claim 34, wherein the sensor device is formed as a cylinder with an outer diameter of less than about 25 mm and a length of less than about 50 mm.

39. A pharmaceutical status monitoring system comprising
at least one package according to claim 1; and
a control unit disposed outside the package and configured to communicate with the sensor device through the packaging to retrieve data indicative of past environmental conditions within the interior volume.
